(19) United States
(12) Patent Application Publication
(10) Pub. No.: US 2016/0229138 A1
(43) Pub. Date: Aug. 11, 2016

(54) TRANSFER ASSEMBLY FOR TRANSFERRING TIRE COMPONENTS

(71) Applicant: VMI HOLLAND B.V., Epe (NL)

(72) Inventors: Henk-Jan Grolleman, Eerbeek (NL); Luuk van Tienen, Epe (NL)

(21) Appl. No.: 15/022,672

(22) PCT Filed: Jul. 3, 2014
(86) PCT No.: PCT/NL2014/050442

§ 371 Date: Mar. 17, 2016

(30) Foreign Application Priority Data
Oct. 4, 2013 (NL) 2011555

(51) Int. Cl. B29D 30/00; B29D 30/28; B29D 30/20

(52) U.S. Cl. CPC B29D 30/0016; B29D 30/20; B29D 30/28; B29D 2030/0038

(57) ABSTRACT

A transfer assembly and a method for transferring tire components to a building drum, wherein the transfer assembly is provided with a first transfer drum including a circumferential surface and a cylindrical transfer drum volume, wherein the first transfer device further includes a first stitcher unit for stitching the first tire component when the first tire component has been transferred by the first transfer drum onto the building drum, wherein the first stitcher unit includes a stitching element for applying pressure to the first tire component and a stitcher deployment actuator for moving the stitching element with respect to the first transfer drum between a retracted position in which the stitching element is located within the transfer drum volume of the first transfer drum and an extended position in which the stitching element is located outside of the transfer drum volume.

### BACKGROUND

The invention relates to a transfer assembly for transferring tire components.

Transfer assemblies are used in tire building machines for transferring tire components to a building drum. A known transfer assembly comprises a transfer drum with circumferential surface around which a tire component is applied. The tire component is subsequently transferred from the circumferential surface of the transfer drum to the building drum. After the transfer, the transfer drum is moved out of the way and a separate, individually moveable stitching unit is moved towards the tire component on the building drum for stitching the tire component on the building drum.

It is an object of the present invention to provide an alternative transfer assembly for transferring tire components.

### SUMMARY OF THE INVENTION

According to a first aspect, the invention provides a transfer assembly for transferring tire components to a building drum, wherein the transfer assembly is provided with a first transfer device comprising a first transfer drum for transferring a first tire component to the building drum, wherein the first transfer drum comprises a circumferential surface around which the first tire component is to be applied, wherein the first transfer drum is rotatable about a rotational axis concentric to the circumferential surface and has a cylindrical transfer drum volume defined by the circumferential surface and two side planes extending perpendicular to the rotational axis at the extremities of the circumferential surface, wherein the first transfer device further comprises a first stitcher unit for stitching the first tire component when the first tire component has been transferred by the first transfer drum onto the building drum, wherein the first stitcher unit comprises a stitching element for applying pressure to the first tire component and a stitcher deployment actuator for moving said stitching element with respect to the first transfer drum between a retracted position in which the stitching element is located within the transfer drum volume of the first transfer drum and an extended position in which the stitching element is located outside of the transfer drum volume of the first transfer drum.

By retracting the first stitcher unit into the transfer drum volume of the first transfer drum, the space occupied by said first stitcher unit when not in use for stitching can be reduced. Thus, a more compact transfer assembly can be obtained.

In an embodiment the stitcher deployment actuator is arranged for moving the stitching element of the first stitcher unit between the retracted position and the extend position through one of the side planes of the first transfer drum in a direction parallel or substantially parallel to the rotational axis of the first transfer drum. As a result, the first stitcher unit can be moved through one of the side planes into an extended position to the side of the transfer drum.

In an embodiment the circumferential surface of the first transfer drum defines an outer diameter of the first transfer drum, wherein the first stitcher unit comprises a pressing actuator which is arranged for moving the stitching element, in the extended position, with respect to the first transfer drum between a passive position within said outer diameter and an active pressing position at least partially outside said outer diameter. The stitching element, in the active pressing position, can be brought into pressing contact with the tire components on a building drum prior without the transfer drum contacting said tire components. Thus, the tire components can be stitched by the stitching element extending from the transfer drum, without the transfer drum interfering with the stitching.

In an embodiment the pressing actuator is arranged for moving the stitching element of the first stitcher unit between the passive position and the active pressing position in a radial or substantially radial direction with respect to the rotational axis of the first transfer drum. By moving the stitching element radially, the distance to be travelled to the active pressing position can be kept to a minimum.

In an embodiment the first transfer device is provided with a transfer drum base for rotatably supporting the first transfer drum, wherein the first stitcher unit is rotationally fixed with respect to the transfer drum base associated with the first transfer drum. The first stitcher unit can thus be moved with respect to the first transfer drum without rotating together with said first transfer drum.

In an embodiment the first stitcher unit comprises a stitcher unit base which is in a fixed position with respect to the transfer drum base. The stitcher unit base can provide a stable basis for relative movements of the first stitcher unit with respect to the first transfer drum.

In an embodiment the stitcher deployment actuator is arranged between the stitching element and stitcher unit base for moving the stitching element relative to said stitcher unit base. In this manner, the stitching element can be moved relative to the stitcher unit base, and thus the transfer drum base and the first transfer drum rotatably supported thereon.

In an embodiment the transfer drum base and the stitcher unit base of the first transfer device are integrated into a common base for the first transfer drum and the first stitcher unit. By having a common base, the first transfer drum and the first stitcher unit can be moved in unison.

In an embodiment the first transfer drum is provided with a sidewall at one of the extremities of the circumferential surface, wherein the first transfer drum is provided with an opening in the sidewall which allows for the passage of the stitching element of the first stitcher unit from the retracted position at one side of the sidewall, to the extended position on the other side of the sidewall. The sidewall can provide structural strength to the transfer drum, while the opening in the sidewall at the same time can facilitate the passage of the first stitcher unit.

In an embodiment the opening in the sidewall of the first transfer drum, in at least one angular position of the first transfer drum about the rotational axis, is located directly opposite to the first stitcher unit in a direction parallel or substantially parallel to the rotational axis of the first transfer drum. In said one angular position, the first stitcher unit can be moved between the retracted position and the extended position without interference with the sidewall of the first transfer drum.

In an embodiment the transfer assembly is provided with a first rotational drive arranged for driving the first transfer drum in a rotation about the rotational axis and a control system for controlling said first rotational drive, wherein the control system is arranged for positioning and holding the transfer drum in said at least one angular position when the stitching element of the first stitcher unit is in the extended position or is being moved between the retracted position and the extended position. This can prevent rotation of the first transfer drum when the first stitcher unit is not fully retracted within the transfer drum volume.

In an embodiment the first transfer device comprises an axial movement actuator for moving the first transfer drum in an axial direction parallel to or substantially parallel to the rotational axis thereof, wherein the stitching element of the first stitcher unit, in the extended position, is arranged to be moved in the axial direction in unison with first transfer drum. Preferably, the first transfer device comprises a radial movement actuator for moving the first transfer drum in a radial direction with respect to the rotational axis thereof, wherein the stitching element of the first stitcher unit, in the extended position, is arranged to be moved in the radial direction in unison with first transfer drum. Thus, the same actuators that are used to move the first transfer drum for transfer purposes can also be used for moving the stitching element of the first stitcher unit for stitching purposes. Separate tracks, drives or actuators of the prior art can thus be eliminated.

In an embodiment the transfer assembly further comprises a transfer assembly base, wherein the axial movement actuator and the radial movement actuator are arranged between the transfer assembly base and the first transfer drum for moveably supporting the first transfer drum on said transfer assembly base, wherein the first stitcher unit is arranged at the side of the first transfer drum with respect to the axial movement actuator and the radial movement actuator. In other words, the first stitcher unit can be placed downstream of the actuators with respect to the transfer assembly base, and can thus be driven by the same actuators as the first transfer drum.

In a preferred embodiment the stitching element, in the retracted position, is located completely within the transfer drum volume of the first transfer drum.

In an embodiment the stitching element of the first stitcher unit is a stitching roll with a circumferential pressing surface and a center line concentric to said circumferential pressing surface, wherein the center line of the stitching roll extends parallel or substantially parallel to the rotational axis of the first transfer drum. Thus, stitching can be performed in the same orientation as the first transfer drum.

In an embodiment the transfer assembly further comprises a second transfer device for transferring a second tire component to the building drum, wherein the second transfer device comprises the same features according to any one of the preceding claims as the first transfer device, in particular a second transfer drum and a second stitcher unit, wherein the second transfer drum and the second stitcher unit are mirrored with respect to the first transfer drum and the first stitcher unit, respectively, in a mirror plane perpendicular to the rotational axis of the first transfer drum. The first transfer device and the second transfer device can simultaneously transfer and subsequently stitch tire components on the building drum.

In an embodiment the transfer drums face each other at the side planes through which the stitcher units extends in the extended position. Preferably, the stitching elements, in the extended positions thereof, extend in between the transfer drums. The stitcher units can thus be used to stitch tire components between the axial positions of the transfer drums. In particular, the transfer drums can be kept out of the way of the stitcher units when the stitcher units are moved towards each other, such that the stitcher units can be moved to a starting position closely towards each other, theoretically even until they are in mutual contact.

In an embodiment the axial movement actuators are arranged for moving the transfer drums in their respective axial directions between a mutually spaced apart position and a mutually closer position, wherein in the mutually closer position, the stitching element of one of the transfer devices, in the extended position thereof, would interfere with the transfer drum of the other transfer device, wherein, in said mutually closer position, the stitcher deployment actuators of the stitcher units are arranged for retracting the stitching elements to their respective retracted positions. This is particularly useful when the transfer drum have to approach each other in the axial direction, in which situation the retracted stitcher units allow the transfer drums to approach each other very closely. Theoretically, the retracted stitcher units allow the transfer drum to approach each other until the sidewalls thereof are in mutual contact.

In an embodiment the transfer drums are arranged to be moved in a symmetrically synchronous manner with respect to the mirror plane. Preferably, the stitcher units are arranged to be moved in a symmetrically synchronous manner with respect to the mirror plane. The tire components can thus be applied and subsequently stitched in a similar or symmetrical manner.

According to a second aspect, the invention provides a tire building machine comprising the transfer assembly according to any one of the preceding claims and a building drum for receiving the first tire component from the first transfer drum, wherein the radial movement actuator and the axial movement actuator are arranged for moving the first stitcher unit with respect to the building drum for the purpose of stitching. Preferably, the building drum has a rotational axis, wherein the axial movement actuator is arranged for moving the first stitcher unit parallel to or substantially parallel to the rotational axis of the building drum. The first stitcher unit can thus be moved relative to the building drum by the same actuators associated with the first transfer drum.

According to a third aspect, the invention provides a method for transferring tire components to a building drum with the use of a transfer assembly, wherein the transfer assembly is provided with a first transfer device comprising a first transfer drum for transferring a first tire component to the building drum, wherein the first transfer drum comprises a circumferential surface around which the first tire component is to be applied, wherein the first transfer drum is rotatable about a rotational axis concentric to the circumferential surface and has a cylindrical transfer drum volume defined by the circumferential surface and two side planes extending perpendicular to the rotational axis at the extremities of the circumferential surface, wherein the first transfer device further comprises a first stitcher unit for stitching the first tire component when the first tire component has been transferred by the first transfer drum onto the building drum, wherein the first stitcher unit comprises a stitching element for applying pressure to the first tire component and a stitcher deployment actuator, wherein the method comprises the step of activating the stitcher deployment actuator to move said stitching element with respect to the first transfer drum between a retracted position in which the stitching element is located within the transfer drum volume and an extended position in which the stitching element is located outside of the transfer drum volume of the first transfer drum.

By retracting the first stitcher unit into the transfer drum volume of the first transfer drum, the space occupied by said first stitcher unit when not in use for stitching can be reduced. Thus, a more compact transfer assembly can be obtained.

In an embodiment the stitching element of the first stitcher unit is moved between the retracted position and the extend position through one of the side planes of the first transfer drum in a direction parallel or substantially parallel to the rotational axis of the first transfer drum. As a result, the first stitcher unit can be moved through one of the side planes into an extended position to the side of the transfer drum.

In an embodiment the circumferential surface of the first transfer drum defines an outer diameter of the first transfer drum, wherein the first stitcher unit comprises a pressing actuator, wherein the method comprises the step of activating the pressing actuator to move the stitching element, in the extended position, with respect to the first transfer drum between a passive position within said outer diameter and an active pressing position at least partially outside said outer diameter. The stitching element, in the active pressing position, can be brought into pressing contact with the tire components on a building drum prior without the transfer drum contacting said tire components. Thus, the tire components can be stitched by the stitching element extending from the transfer drum, without the transfer drum interfering with the stitching.

In an embodiment the stitching element of the first stitcher unit is moved between the passive position and the active pressing position in a radial or substantially radial direction with respect to the rotational axis of the first transfer drum. By moving the stitching element radially, the distance to be travelled to the active pressing position can be kept to a minimum.

In an embodiment the first transfer drum is provided with a sidewall at one of the extremities of the circumferential surface, wherein the first transfer drum is provided with an opening in the sidewall which allows for the passage of the stitching element of the first stitcher unit from the retracted position at one side of the sidewall, to the extended position on the other side of the sidewall, wherein the opening in the sidewall of the first transfer drum, in at least one angular position of the first transfer drum about the rotational axis, is located directly opposite to the first stitcher unit in a direction parallel or substantially parallel to the rotational axis of the first transfer drum, wherein the method comprises the step of positioning and holding the transfer drum in said at least one angular position when the stitching element of the first stitcher unit is in the extended position or is being moved between the retracted position and the extended position. In said one angular position, the first stitcher unit can be moved between the retracted position and the extended position without interference with the sidewall of the first transfer drum. The holding of the first transfer drum can prevent rotation of the first transfer drum when the first stitcher unit is not fully retracted within the transfer drum volume.

In an embodiment the first transfer device comprises an axial movement actuator for moving the first transfer drum in an axial direction parallel to or substantially parallel to the rotational axis thereof, wherein the method comprises the step of moving the stitching element of the first stitcher unit, in the extended position, in the axial direction in unison with first transfer drum. Preferably, the first transfer device comprises a radial movement actuator for moving the first transfer drum in a radial direction with respect to the rotational axis thereof, wherein the method comprises the step of moving the stitching element of the first stitcher unit, in the extended position, in the radial direction in unison with first transfer drum. Thus, the same actuators that are used to move the first transfer drum for transfer purposes can also be used for moving the stitching element of the first stitcher unit for stitching purposes. Separate tracks, drives or actuators of the prior art can thus be eliminated.

In an embodiment the transfer assembly further comprises a second transfer device for transferring a second tire component to the building drum, wherein the second transfer device comprises the same features according to any one of the preceding claims as the first transfer device, in particular a second transfer drum and a second stitcher unit, wherein the second transfer drum and the second stitcher unit are mirrored with respect to the first transfer drum and the first stitcher unit, respectively, in a mirror plane perpendicular to the rotational axis of the first transfer drum, wherein the method comprises the step of axially moving the stitching elements of both stitcher units between their respective retracted positions and their respective extended positions. The first transfer device and the second transfer device can simultaneously transfer and subsequently stitch tire components on the building drum.

In an embodiment the stitcher units axially move towards each other when moving towards the extended positions. The stitcher units can thus be used to stitch tire components between the axial positions of the transfer drums. In particular, the transfer drums can be kept out of the way of the stitcher units when the stitcher units are moved towards each other, such that the stitcher units can be moved closely towards each other, theoretically even until they are in mutual contact.

In an embodiment the transfer drums are moved in their respective axial directions between a mutually spaced apart position and a mutually closer position, wherein in the mutually closer position, the stitching element of one of the transfer devices, in the extended position thereof, would interfere with the transfer drum of the other transfer device, wherein, in said mutually closer position, the stitcher deployment actuators retract the stitching elements to their respective retracted positions. This is particularly useful when the transfer drum have to approach each other in the axial direction, in which situation the retracted stitcher units allow the transfer drums to approach each other very closely. Theoretically, the retracted stitcher units allow the transfer drum to approach each other until the sidewalls thereof are in mutual contact.

In an embodiment the transfer drums moved in a symmetrically synchronous manner with respect to the mirror plane. Preferably, the stitcher units are moved in a symmetrically synchronous manner with respect to the mirror plane. The tire components can thus be applied and subsequently stitched in a similar or symmetrical manner.

In an embodiment the pressing element of at least one of the stitcher units is pressed against a first area of the tire components that at least partly overlaps a second area of the tire components that is subsequently pressed by the pressing element of the other of the stitcher units. In this manner, it can be ensured that the entire area of the tire components is pressed or stitched, in particular also the area located between the pressing elements of the stitcher units when both pressing elements are arranged symmetrically with respect to the mirror plane.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1A shows a side view of a tire building machine with a transfer assembly in a rest mode according to a first embodiment of the invention;

FIG. 1B shows a top view in cross section of the tire building machine according to the line IB-IB in FIG. 1A;

FIGS. 2A and 2B show the tire building machine according to the FIGS. 1A and 1B, respectively, with the transfer assembly in an applying mode;

FIGS. 3A and 3B show the tire building machine according to the FIGS. 1A and 1B, respectively, with the transfer assembly in a stitching mode;

FIG. 4 shows a top view in cross section of an alternative tire building machine with an alternative transfer assembly in an applying mode according to a second embodiment of the invention; and

FIG. 5 shows the alternative tire building machine according to the FIG. 4 with the alternative transfer assembly in a stitching mode.

### DETAILED DESCRIPTION OF THE INVENTION

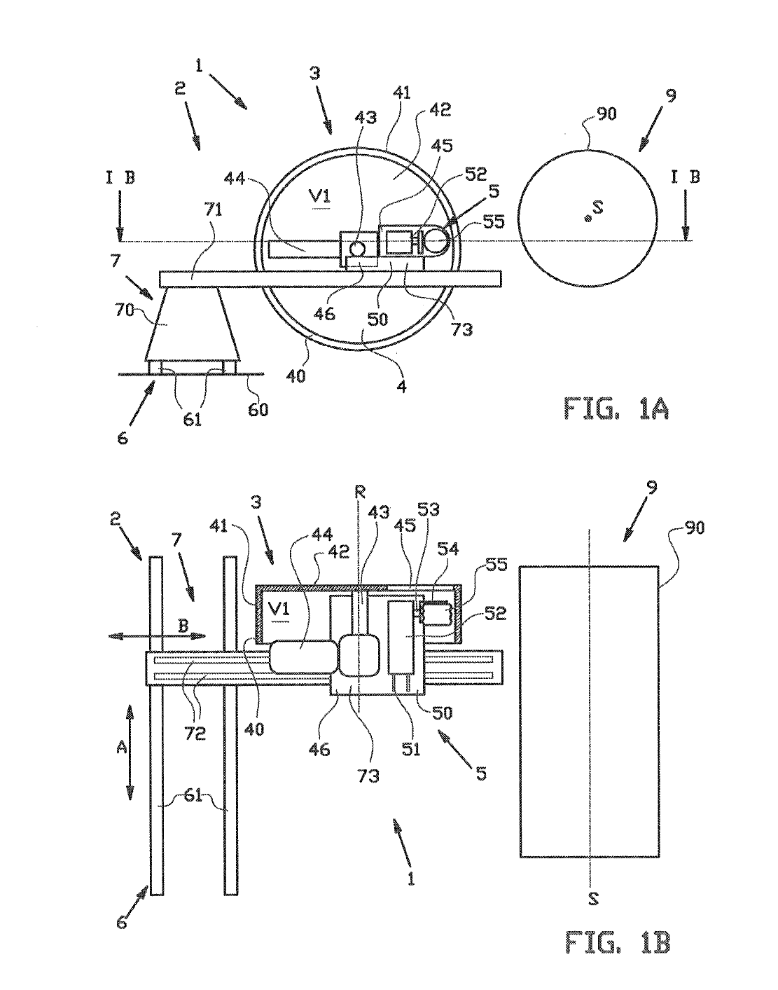

FIGS. 1A, 1B, 2A, 2B, 3A and 3B show a tire building machine 1 with a transfer assembly 2 according to a first embodiment of the invention. The transfer assembly is used for transferring tire components, preferably strip shaped tire components such as chafers (not shown), to a building drum 9.

The transfer assembly 2 comprises a first transfer device 3 with a first transfer drum 4 for transferring a first tire component to the building drum 9 and a first stitcher unit 5 for stitching the first tire component on the building drum 9 after its transfer by the first transfer drum 4. The transfer assembly 2 is provided with a transfer assembly base 6 which is fixedly mounted to a horizontally or substantially horizontally extending floor, for example a factory floor 60. The transfer assembly base 6 is provided with axial tracks 61 which, in this exemplary embodiment, are horizontally arranged with respect to the floor 60. The transfer assembly 2 comprises a first actuating assembly 7 for moving and positioning the first transfer device 3 with respect to said transfer assembly base 6 and the building drum 9.

As shown in FIGS. 1A and 1B, the first transfer drum 4 comprises a circumferential wall 40 which defines a circumferential outer surface 41 for receiving tire components. Preferably, the transfer drum 4 is provided with retaining means (not shown), such as magnets and/or vacuum openings of a vacuum system, for retaining the tire components around its circumferential surface 41. The first transfer drum 4 is rotatably arranged about a rotational axis R concentric to the circumferential surface 41. The rotational axis R defines the axial direction A of the first transfer drum 4. The circumferential surface 41 of the first transfer drum 4 enclose or define a cylindrical transfer drum volume V1, which is further delimited by two imaginary radial side planes (not shown), extending perpendicular to the rotational axis R. At one of the radial side planes, the first transfer drum 4 comprises a radial sidewall 42 which substantially closes of the transfer drum volume V1 at said one radial side plane.

The first transfer drum 4 is further provided with an axle 43 at its rotational axis R, which axle 43 is coupled, at one end, to the center of the radial sidewall 42 and, at the opposite end, is rotatably supported on a transfer drum base 46. The transfer drum base 46 is moveably arranged on the first actuating assembly 7 in a manner which will be described hereafter. The first transfer device 3 is provided with a first rotational drive for driving the first transfer drum 4 in a rotation about its rotational axis R with respect to the first actuating assembly 7, the transfer assembly base 6 and the building drum 9. The transfer assembly 2 comprises a control system (not shown) for sending control signals to and thereby controlling the rotational drive 44 of the first transfer drum 4. The control system is particularly arranged for accurately slowing down and stopping or holding the first transfer drum 4 in a predetermined rotational position or angular position with respect to its rotational axis R.

The first transfer drum 4 is provided with a passage or an opening 45 for allowing the passage of at least a part of the first stitcher unit 5 in a direction parallel or substantially parallel to the rotational axis R of the first transfer drum 4. In particular, the contour of the opening 45 is adapted to match, preferably with some play, clearance or tolerance, the contour of the first stitching unit 5 in said direction when the first transfer drum 4 is in a particular angular position.

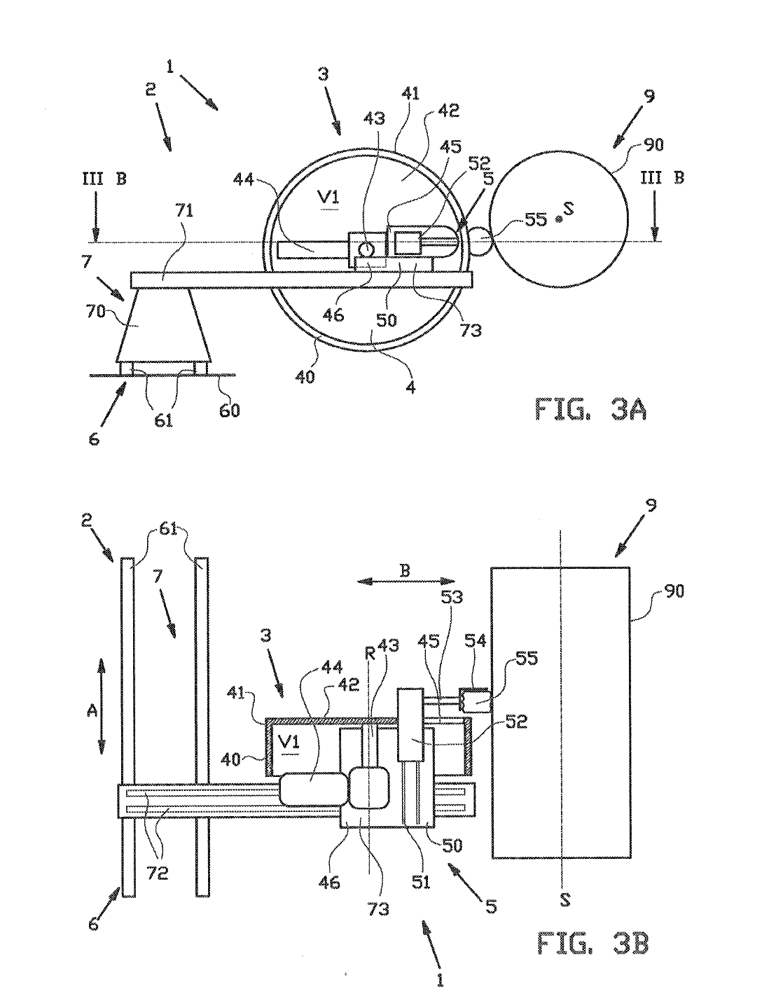

As shown in FIGS. 1A and 1B, the first stitcher unit 5 comprises a stitcher unit base 50, a deployment track 51, an actuator element 52, a stitcher arm 53, a stitcher holder 54 and a stitching element in the form of a stitching wheel or stitching roller 55. The stitching roller 55 is rotatably supported in the stitcher holder 54, to be rotatable about an axis parallel to the rotational axis of the first transfer drum 4. The stitcher arm 53 operationally connects the stitcher holder 54 to the actuator element 52. The actuator element 52 comprises a pressing actuator in the form of a pneumatic drive. The pneumatic drive comprises a cylinder (not shown) to which the stitcher arm 53 fits as a plunger. The pressing actuator in the actuator element 52 is arranged for moving the stitcher arm 53, and thus the stitcher holder 54 and the stitching roller 55 in or substantially parallel to a radial direction with respect to the rotational axis R of the first transfer drum 4 between a passive position as shown in FIGS. 1A and 1B, and an active pressing position as shown in FIGS. 3A and 3B. The actuator element 52 further comprises a stitcher deployment actuator (not shown), for example a linear drive, which cooperates with the deployment track 51 for moving the actuator element 52, the stitcher arm 53, the stitcher holder 54 and the stitching roller 55 in a direction parallel to the rotational axis R of the first transfer drum 4 between a retracted position, as shown in FIGS. 1A and 1B, and an extended position as shown in FIGS. 3A and 3B. The stitcher base 50 is moveably arranged on the first actuating assembly 7 in a manner which will be described hereafter.

As shown in FIGS. 1A and 1B, the first actuating assembly 7 comprises an axial movement actuator 70, a first transfer drum arm 71 and a radial track 72 arranged on the first transfer drum arm 71. The axial movement actuator 70 is arranged between the axial track 61 of the transfer assembly base 6 and the first transfer drum arm 71 for, in cooperation with the axial track 61, moving said first transfer drum arm 71 over the axial track 61 in or parallel to the axial direction A of the first transfer drum 4. The radial track 72 extends substantially parallel to a radial direction B of the first transfer drum 4 over the first transfer drum arm 71, perpendicular to the axial direction A of the first transfer drum 4. In this exemplary embodiment, the radial track 72 extends substantially parallel to or horizontally with respect to the floor 60. The first actuating assembly 7 is provided with a radial movement actuator (not shown) between the transfer drum base 46, the stitcher base 50 and the radial track 72, for moving the transfer drum base 46 and the stitcher base 50 in a direction radial to, substantially radial to or substantially parallel to a radial direction B of the first transfer drum 4 over the first transfer drum arm 71.

In this exemplary embodiment, the transfer drum base 46 and the stitcher unit base 50 are integrally formed or are fixedly interconnected to form a common base 73 that is moveable by a single radial movement actuator over the radial track 72 in the radial direction B.

As shown in FIGS. 1A and 1B, the building drum 9 comprises a circumferential surface 90 and a rotational axis S extending in the center of the building drum 9, concentrically with respect to the circumferential surface 90.

A method for transferring tire components to the building drum 9, in particular a method of applying and stitching tire components on the circumferential surface 90 of the building drum 9 will be described hereafter with reference to FIGS. 1A, 1B, 2A, 2B, 3A and 3B.

In FIGS. 1A and 1B, the tire building machine 1 is shown with the transfer assembly 2 in an inactive mode or rest mode. In the rest mode, the first transfer device 3 has been moved away from the building drum 9 along the radial track 72 of the first actuating assembly 7, so that both the circumferential surface 41 of the first transfer drum 4 and the stitching roller 55 are spaced apart from the circumferential surface 90 of the building drum 9. The first stitcher unit 5 has been moved by the stitcher deployment actuator of the actuating element 52 to the retracted position, to be fully contained within or to be internal to the transfer drum volume V1 of the first transfer drum 4.

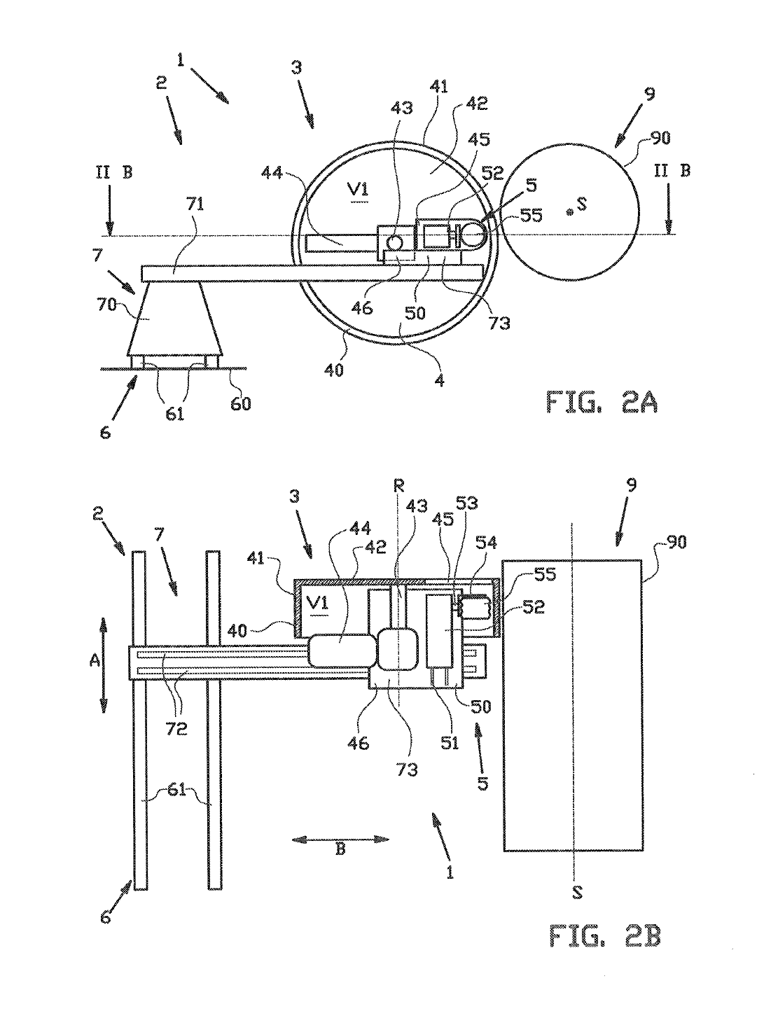

In FIGS. 2A and 2B, the tire building machine 1 is shown with the transfer assembly 2 in an application or applying mode. In the applying mode, the axial movement actuator 70 has been actuated to move the first transfer device 3 parallel to the axial direction A of the first transfer drum 4 and to position the first transfer device 3 in a desired axial position with respect to the building drum 3. The radial movement actuator has been actuated to move the common base 73 for the first transfer drum 4 and the first stitcher unit 5 in the radial direction B over the radial track 72 towards the building drum 9. The circumferential surface 41 of the first transfer drum 4 has been moved into close proximity of the circumferential surface 90 of the building drum 9, such that tire components arranged around the circumferential surface 41 of the first transfer drum 4 can be transferred or applied onto the circumferential surface 90 of the building drum 9. Because of the common base 73, the first stitcher unit 5 has been moved together with or in unison with the first transfer drum 4 towards the building drum 9. The first stitcher unit 5 is however still in its retracted position within the transfer drum volume V1 of the first transfer drum 4. The first stitcher unit 5 is clear of the moving parts of the first transfer drum 4, in particular of the sidewall 42 and the circumferential wall 40, so that the first transfer drum 4 can be rotated about the rotational axis R without hindrance or obstruction by the first stitcher unit 5.

In FIGS. 3A and 3B, the tire building machine 1 is shown with the transfer assembly 2 in a stitching mode. The transfer assembly switches to stitching mode after the tire components have been fully transferred from the first transfer drum 4 and are completely applied on the building drum 9. The control system controls the rotational drive 44 of the first transfer drum 4 so that the rotation of the first transfer drum 4 is slowed down and so that the first transfer drum 4 comes to a standstill in an angular position in which the opening 45 in the sidewall 42 is directly opposite or across from the first stitcher unit 5, when considered in a direction parallel to the axial direction A of the first transfer drum 4. The radial movement actuator is actuated to move the common base 73 for the first transfer drum 4 and the first stitcher unit 5 slightly backwards or away from the building drum 9. The common base 73 stays within a distance from the circumferential surface 90 of the building drum 9 such that first stitcher unit 5 can reach said circumferential surface 90 in a manner which will be described hereafter. Thus, in stitching mode, the movement of the first stitcher unit 5 in the radial direction B is caused by the same radial movement actuator that drives the movement of the first transfer drum 4 in the radial direction B.

In the stitching mode, the stitcher deployment actuator in the actuating element 52 of the first stitching unit 5 is activated to move the actuating element 52, the stitcher arm 53, the stitcher holder 54 and the stitching roller 55 in the axial direction A towards the extended position. In the extended position, at least the stitching roller 55, and in this example also the stitching arm 53 and the stitcher holder 54, are moved through the opening 45 in the sidewall 42 of the first transfer drum 4 and are now fully positioned outside of or external to the transfer drum volume V1 of the first transfer drum 4. The actuating element 52 extends partly through the opening 45 and supports the stitcher arm 53 in the extended position on the stitcher unit base 50 section of the common base 73. In the extended position, the pressing actuator of the actuating element 52 has been activated to move the stitching arm 53 radially outward with respect to the rotational axis R of the first transfer drum 4, such that the stitcher holder 54 and the stitching roller 55 at the end thereof are moved towards the circumferential surface 41 of the first transfer drum 4 into the active pressing position. In the active pressing position, the stitching roller 55 at least partly extends in the radial direction B past the outer diameter or the circumferential surface 41 of the first transfer drum 4.

In the active pressing position, the stitching roller 55 is brought into stitching or pressing contact with the tire components on the circumferential surface 90 of the building drum 9. The first transfer device 3 can subsequently be moved by the axial movement actuator 70 to move with respect to the base 6 in the axial direction A of the first transfer drum 4, thereby displacing the first transfer drum 4 and the first stitcher unit 5 together or in unison parallel to the rotational axis S of the building drum 9. During said displacement, the stitching roller 55 is moved in its active pressing position back and/or forth along the circumferential surface 90 of the building drum 9 to stitch the tire components and/or to disperse air pockets underneath the tire components. Thus, the axial movement of the stitcher roller 55 is caused by the same axial movement actuator 70 that drive the axial movement of the first transfer drum 4.

It is noted that other tire components may be supplied and applied to the building drum 9 prior to stitching in the stitching mode. These other tire components may be supplied by a different apparatus than the transfer assembly 2. Thus, the transfer assembly 2 can be used for stitching a laminate of tire components, wherein the tire components which were supplied by the transfer assembly 2 do not necessarily form the radially outer layer of said laminate. For example, when the tire components supplied by the transfer assembly 2 are chafers, these are typically covered by an additional body ply or belt layer, which layer may leave air pockets in the laminate, in particular at the location of the chafers. Thus, during stitching mode, the stitching roller 55 comes into pressing contact with the belt layer, and is used to disperse the air pockets in the laminate at the chafers via its pressing contact with the belt layer.

After the stitching of the tire components at the building drum 9 has been completed, the stitching roller 55 can be retracted away from the circumferential surface 90 of the building drum 9 to the passive position, at which point the stitcher deployment actuator of the actuating element 52 can be reversely driven to move the stitching roller 55 back into the retracted position within the transfer drum volume V1 of the first transfer drum 4.

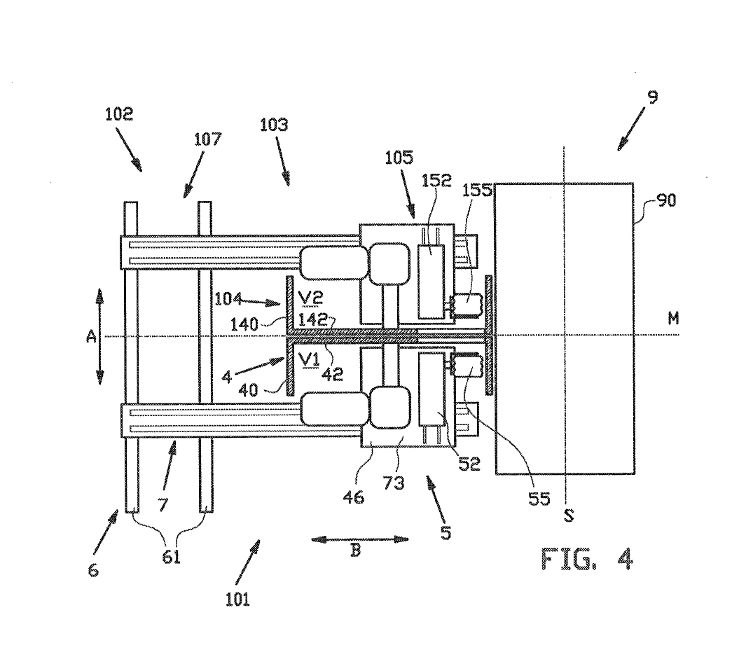

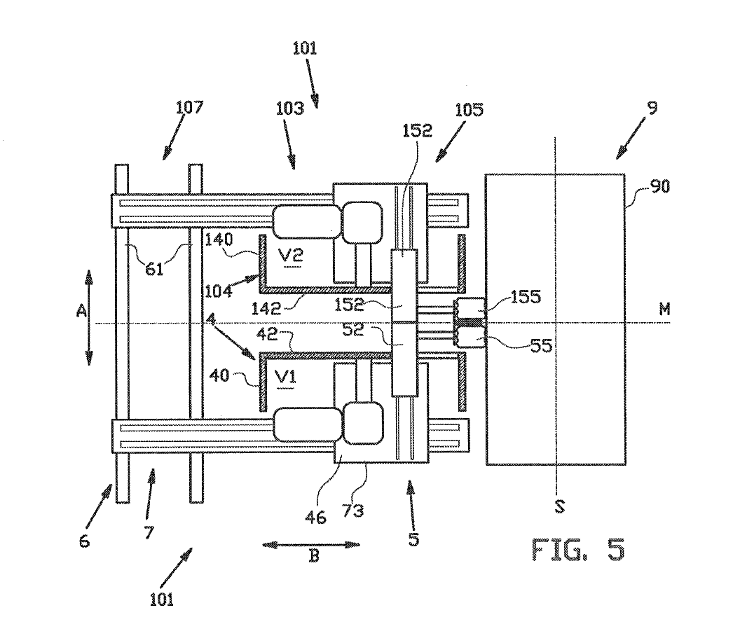

FIGS. 4 and 5 show an alternative tire building machine 101 according to a second embodiment of the invention. The alternative tire building machine 101 comprises an alternative transfer assembly 102 which, in addition to the first transfer device 3 according to the aforementioned description, is provided with a second transfer device 103 for transferring a second tire component to the building drum 9. The second transfer device 103 comprises the same features as the first transfer device 3, yet mirror in a mirror plane M extending perpendicular to the rotational axis R of the first transfer drum 4. Because of the corresponding features of the two transfer devices 3, 103, the features of the second transfer device 103 will only be briefly discussed below.

As shown in FIGS. 4 and 5, the second transfer device 103 comprises a second transfer drum 104, a second stitcher unit 105 and a second actuating assembly 107. The second actuating assembly 107 is arranged for individual or synchronous movement of the second transfer device 103 with respect to the first transfer device 3 along the base 6 in the axial direction A and the radial direction B. The movements of the second transfer device 103 are preferably mirrored synchronous movements with respect to the movements of the first transfer device 3 at the other side of the mirror plane M. By having two transfer devices 3, 103, two tire components can be transferred to the building drum 9 simultaneously and subsequently stitched on the building drum 9 simultaneously.

Analogous to the first transfer drum 4, the second transfer drum 104 comprises a circumferential wall 140 defining a circumferential surface and a sidewall 142 closing of the transfer drum volume V2 of the second transfer drum 104 at a radial side plane that faces the sidewall 42 of the first transfer drum 4. Analogous to the first stitcher unit 5, the second stitcher unit 105 comprises an actuating element 152 for deploying and moving a stitching element in the form of a stitching roller 155.

In FIG. 4, the transfer devices 3, 103 are shown in applying mode. The stitcher units 5, 105 are in the retracted positions inside the transfer drum volumes V1, V2 of their respective transfer drums 4, 104. Thus, the transfer drum 4, 104 can approach each other in the axial direction A into a close, adjacent or juxtaposed position until, theoretically, the sidewalls 42, 142 are in contact with each other. The invention is however also of use in situation in which the transfer drums 4, 104 are spaced apart in the axial direction, but not enough to prevent interference of the stitching roller 55, 155 of one of the transfer devices 3, 103, when in the extended position, with the transfer drum 4, 104 of the other of the transfer devices 3, 103. The stitching rollers 55, 155, in their retracted positions, then allow for the, transfer drum 4, 104 to approach each other, despite of the theoretical interference with the stitching rollers 55, 155 in the extended position. In practice, this allows for the tire components to be applied on the building drum 9 in close, neighboring, adjacent or juxtaposed axial positions.

In FIG. 5, the transfer devices 3, 103 are shown in stitching mode. The transfer drums 4, 104 are sufficiently moved apart in the axial direction A to allow for the deployment in between of the respective stitching units 5, 105 to their extended positions. The stitcher rollers 55, 155 are now located in the space created between the sidewalls 42, 142 of the respective transfer drums 4, 104 and can be moved to their respective active pressing positions between said transfer drums 4, 104. Again, the subsequent stitching movements in the axial direction A can be controlled by the same actuating assemblies 7, 107 that are used for controlling the movements in the axial direction A of the transfer drums 4, 104.

During stitching mode, the stitcher rollers 55 are pressed against the tire components on the building drum 9 at the middle or axial center of the circumferential center thereof, and are subsequently symmetrically driven axially outward by their respective actuating assemblies 7, 107 to disperse air pockets trapped underneath the tire components outwards.

Optionally, the symmetrical outward movement of the stitching rollers 55 is preceded by an a-synchronous movement to ensure that the entire area of the tire components is pressed or stitched, in particular also the area located between the stitching rollers 55 of the stitcher units 5, 105 when both stitching rollers 55 are arranged symmetrically with respect to the mirror plane M. The a-synchronous movement involves moving the stitching roller 55 of at least one of the stitcher units 5, 105 in the active pressing position along a first area of the tire components that at least partly overlaps a second area of the tire components that is subsequently pressed by the stitching roller 55 of the other of the stitcher units 105.

It is to be understood that the above description is included to illustrate the operation of the preferred embodiments and is not meant to limit the scope of the invention. From the above discussion, many variations will be apparent to one skilled in the art that would yet be encompassed by the spirit and scope of the present invention.

In summary, the invention relates to a transfer assembly and a method for transferring tire components to a building drum, wherein the transfer assembly is provided with a first transfer drum comprising a circumferential surface and a cylindrical transfer drum volume, wherein the first transfer device further comprises a first stitcher unit for stitching the first tire component when the first tire component has been transferred by the first transfer drum onto the building drum, wherein the first stitcher unit comprises a stitching element for applying pressure to the first tire component and a stitcher deployment actuator for moving said stitching element with respect to the first transfer drum between a retracted position in which the stitching element is located within the transfer drum volume of the first transfer drum and an extended position in which the stitching element is located outside of the transfer drum volume.

1-37. (canceled)

38. A transfer assembly for transferring tire components to a building drum, wherein the transfer assembly is provided with a first transfer device comprising a first transfer drum for transferring a first tire component to the building drum, wherein the first transfer drum comprises a circumferential surface around which the first tire component is to be applied, wherein the first transfer drum is rotatable about a rotational axis concentric to the circumferential surface and has a cylindrical transfer drum volume defined by the circumferential surface and two side planes extending perpendicular to the rotational axis at the extremities of the circumferential surface, wherein the first transfer device further comprises a first stitcher unit for stitching the first tire component when the first tire component has been transferred by the first transfer drum onto the building drum, wherein the first stitcher unit comprises a stitching element for applying pressure to the first tire component and a stitcher deployment actuator for moving said stitching element with respect to the first transfer drum between a retracted position in which the stitching element is located within the transfer drum volume of the first transfer drum and an extended position in which the stitching element is located outside of the transfer drum volume of the first transfer drum.

39. The transfer assembly according to claim 38, wherein the stitcher deployment actuator is arranged for moving the stitching element of the first stitcher unit between the retracted position and the extend position through one of the side planes of the first transfer drum in a direction parallel to the rotational axis of the first transfer drum.

40. The transfer assembly according to claim 38, wherein the circumferential surface of the first transfer drum defines an outer diameter of the first transfer drum, wherein the first stitcher unit comprises a pressing actuator which is arranged for moving the stitching element, in the extended position, with respect to the first transfer drum between a passive position within said outer diameter and an active pressing position at least partially outside said outer diameter.

41. The transfer assembly according to claim 40, wherein the pressing actuator is arranged for moving the stitching element of the first stitcher unit between the passive position and the active pressing position in a radial direction with respect to the rotational axis of the first transfer drum.

42. The transfer assembly according to claim 38, wherein the first transfer device is provided with a transfer drum base for rotatably supporting the first transfer drum, wherein the first stitcher unit is rotationally fixed with respect to the transfer drum base associated with the first transfer drum.

43. The transfer assembly according to claim 42, wherein the first stitcher unit comprises a stitcher unit base which is in a fixed position with respect to the transfer drum base.

44. The transfer assembly according to claim 43, wherein the stitcher deployment actuator is arranged between the stitching element and stitcher unit base for moving the stitching element relative to said stitcher unit base.

45. The transfer assembly according to claim 43, wherein the transfer drum base and the stitcher unit base of the first transfer device are integrated into a common base for the first transfer drum and the first stitcher unit.

46. The transfer assembly according to claim 38, wherein the first transfer drum is provided with a sidewall at one of the extremities of the circumferential surface, wherein the first transfer drum is provided with an opening in the sidewall which allows for the passage of the stitching element of the first stitcher unit from the retracted position at one side of the sidewall, to the extended position on the other side of the sidewall.

47. The transfer assembly according to claim 46 wherein the opening in the sidewall of the first transfer drum, in at least one angular position of the first transfer drum about the rotational axis, is located directly opposite to the first stitcher unit in a direction parallel to the rotational axis of the first transfer drum.

48. The transfer assembly according to claim 47, wherein the transfer assembly is provided with a first rotational drive arranged for driving the first transfer drum in a rotation about the rotational axis and a control system for controlling said first rotational drive, wherein the control system is arranged for positioning and holding the transfer drum in said at least one angular position when the stitching element of the first stitcher unit is in the extended position or is being moved between the retracted position and the extended position.

49. The transfer assembly according to claim 38, wherein the first transfer device comprises an axial movement actuator for moving the first transfer drum in an axial direction parallel to the rotational axis thereof, wherein the stitching element of the first stitcher unit, in the extended position, is arranged to be moved in the axial direction in unison with first transfer drum.

50. The transfer assembly according to claim 49, further comprising a transfer assembly base, wherein the axial movement actuator and the radial movement actuator are arranged between the transfer assembly base and the first transfer drum for moveably supporting the first transfer drum on said transfer assembly base, wherein the first stitcher unit is arranged at the side of the first transfer drum with respect to the axial movement actuator and the radial movement actuator.

51. The transfer assembly according to claim 38, wherein the first transfer device comprises a radial movement actuator for moving the first transfer drum in a radial direction with respect to the rotational axis thereof, wherein the stitching element of the first stitcher unit, in the extended position, is arranged to be moved in the radial direction in unison with first transfer drum.

52. The transfer assembly according to claim 38, wherein the stitching element, in the retracted position, is located completely within the transfer drum volume of the first transfer drum.

53. The transfer assembly according to claim 38, wherein the stitching element of the first stitcher unit is a stitching roll with a circumferential pressing surface and a center line concentric to said circumferential pressing surface, wherein the center line of the stitching roll extends parallel to the rotational axis of the first transfer drum.

54. The transfer assembly according to claim 38, further comprising a second transfer device for transferring a second tire component to the building drum, wherein the second transfer device comprises the same features as the first transfer device, including a second transfer drum and a second stitcher unit, wherein the second transfer drum and the second stitcher unit are mirrored with respect to the first transfer drum and the first stitcher unit, respectively, in a mirror plane perpendicular to the rotational axis of the first transfer drum.

55. The transfer assembly according to claim 54, wherein the stitcher deployment actuator is arranged for moving the stitching element of the first stitcher unit between the retracted position and the extend position through one of the side planes of the first transfer drum in a direction parallel to the rotational axis of the first transfer drum, wherein the transfer drums face each other at the side planes through which the stitcher units extends in the extended position.

56. The transfer assembly according to claim 55, wherein the stitching elements, in the extended positions thereof, extend in between the transfer drums.

57. The transfer assembly according to claim 55, wherein the first transfer device comprises an axial movement actuator for moving the first transfer drum in an axial direction parallel to the rotational axis thereof, wherein the stitching element of the first stitcher unit, in the extended position, is arranged to be moved in the axial direction in unison with first transfer drum, wherein the axial movement actuators are arranged for moving the transfer drums in their respective axial directions between a mutually spaced apart position and a mutually closer position, wherein in the mutually closer position, the stitching element of one of the transfer devices, in the extended position thereof, would interfere with the transfer drum of the other transfer device, wherein, in said mutually closer position, the stitcher deployment actuators of the stitcher units are arranged for retracting the stitching elements to their respective retracted positions.

58. The transfer assembly according to claim 54, wherein the transfer drums are arranged to be moved in a symmetrically synchronous manner with respect to the mirror plane.

59. The transfer assembly according to claim 54, wherein the stitcher units are arranged to be moved in a symmetrically synchronous manner with respect to the mirror plane.

60. The tire building machine comprising the transfer assembly according to claim 38 and a building drum for receiving the first tire component from the first transfer drum, wherein the radial movement actuator and the axial movement actuator are arranged for moving the first stitcher unit with respect to the building drum for the purpose of stitching.

61. The tire building machine according to claim 60, wherein the building drum has a rotational axis, wherein the axial movement actuator is arranged for moving the first stitcher unit parallel to the rotational axis of the building drum.

62. A method for transferring tire components to a building drum with the use of a transfer assembly, wherein the transfer assembly is provided with a first transfer device comprising a first transfer drum for transferring a first tire component to the building drum, wherein the first transfer drum comprises a circumferential surface around which the first tire component is to be applied, wherein the first transfer drum is rotatable about a rotational axis concentric to the circumferential surface and has a cylindrical transfer drum volume defined by the circumferential surface and two side planes extending perpendicular to the rotational axis at the extremities of the circumferential surface, wherein the first transfer device further comprises a first stitcher unit for stitching the first tire component when the first tire component has been transferred by the first transfer drum onto the building drum, wherein the first stitcher unit comprises a stitching element for applying pressure to the first tire component and a stitcher deployment actuator, wherein the method comprises activating the stitcher deployment actuator to move said stitching element with respect to the first transfer drum between a retracted position in which the stitching element is located within the transfer drum volume and an extended position in which the stitching element is located outside of the transfer drum volume of the first transfer drum.

63. The method according to claim 62, wherein the transfer assembly further comprises a second transfer device for transferring a second tire component to the building drum, wherein the second transfer device comprises the same features as the first transfer device, including a second transfer drum and a second stitcher unit, wherein the second transfer drum and the second stitcher unit are mirrored with respect to the first transfer drum and the first stitcher unit, respectively, in a mirror plane perpendicular to the rotational axis of the first transfer drum, wherein the method comprises the step of axially moving the stitching elements of both stitcher units between their respective retracted positions and their respective extended positions.
